(19) United States
(12) Patent Application Publication
(10) Pub. No.: US 2006/0133319 A1
(43) Pub. Date: Jun. 22, 2006

(54) Service authorization in a Wi-Fi network interworked with 3G/GSM network

(75) Inventor: Nishi Kant, San Jose, CA (US)

Correspondence Address: GROOVER & HOLMES, BOX 802889, DALLAS, TX, 75380-2889, US

(73) Assignee: Azaire Networks Inc.

(21) Appl. No.: 11/283,546

(22) Filed: Nov. 18, 2005

Related U.S. Application Data
(60) Provisional application No. 60/629,685, filed on Nov. 18, 2004.

(51) Int. Cl. H04Q 7/00

(52) U.S. Cl. 370/331; 370/352

(57) ABSTRACT

An authorization system and method for accessing networks. In one example class of embodiments, the APN (access point name) mechanism of GPRS/UMTS networks is extended to provide service authorization in an interworked WLAN. Example implementations include an external mapping function, and population of an existing authorization database of user profiles and APNs (such as a home location registry) with a global authorization indicator. The global authorization indicator is also preferably stored on a server or node that has authorization functions, which cross references with the user's subscriber profile to determine if WLAN authorization is proper. These innovations permit re-use of the subscriber profile database to perform WLAN authorization without requiring modifications to the 3GPP specifications of the nodes involved.

### CROSS REFERENCE TO RELATED APPLICATIONS

This application claims priority from provisional patent application 60/629,685 filed Nov. 18, 2004, which is hereby incorporated by reference.

### FIELD OF THE INVENTION

The present inventions relate generally to integration of different networks, such as cellular and non-cellular networks, and more specifically to extending authorization of GPRS networks to include an interworked WLAN network.

### BACKGROUND AND SUMMARY OF THE INVENTION

The mobile telecommunications industry is experiencing robust growth which is expected to continue in the foreseeable future. Many different types of networks and services have been deployed to serve consumer needs. For example, various networks covering different ranges and offering different data rates exist, including short range networks like Bluetooth™ that cover only room-sized areas and transfer data in excess of 3 Mb/s, Wi-Fi networks that cover larger areas and provide data rates of around 25 Mb/s, cellular networks like Global System for Mobile communications (GSM) that cover much larger areas and offer kb/s data rates, and satellite networks that are global and transmit data at rates around 144 kb/s.

Global System for Mobile communications is one of the most widely used digital mobile phone system and is the de facto wireless telephone standard in Europe. It was originally defined as a pan-European open standard for a digital cellular telephone network to support voice, data, text messaging and cross-border roaming. GSM is now one of the world's main 2G digital wireless standards. GSM is present in more than 160. GSM is a time division multiplex (TDM) system, implemented on 800, 900, 1800 and 1900 MHz frequencies.

GPRS (General Packet Radio Service) is a radio technology for GSM networks that adds packet-switching protocols, shorter set-up time for ISP connections, and offer the possibility to charge by amount of data sent rather than connect time. GPRS promises to support flexible data transmission rates typically up to 20 or 30 Kbps (with a theoretical maximum of 171.2 Kbps), as well as continuous connection to the network.

GPRS etc. can co-exist with circuit switched services and therefore can use existing GSM physical nodes. However, added nodes are needed to support some GPRS functionality, namely a GGSN (gateway GPRS support node) and SGSN (serving GPRS support node). SGSN provides mobility and session management support (in other words, it is generally responsible for communication between the GPRS network and all the GPRS users located within its service area), while the GGSN provides connectivity between GPRS and external data networks (such as the Internet or WLANs) (i.e., it is the gateway to external networks).

Modern network architectures can be logically divided into three components: user equipment, access networks, and core networks. Core networks can be divided into two distinct domains: circuit switched and packet switched domains. These domains have entities that are common to both, such as those that manage and provide subscription information. One important entity for these functions is the home location register (HLR).

The HLR (Home Location Registry) is the central database in GRPS/UMTS cellular networks that is responsible for authentication and authorization of all subscribers.

The reuse of HLR for WLAN authentication and authorization is key for a successful public WLAN service (a.k.a., interworked WLAN, or iWLAN). Since the public WLAN has emerged as compelling access technology only recently, the current HLRs do not carry WLAN service-specific information. Given the large scale of current deployments of GPRS/UMTS hardware and software, it is not possible to make intrusive modifications to HLRs in order to support WLAN authorization.

An HLR contains subscriber profile information and uses this user-specific profile information to provide service level authorization. GPRS/UMTS systems use Access Point Name (APN) mechanisms for service authorization. A subscriber typically only has access to those GPRS/UMTS services that are identified in the subscriber profile with the corresponding APNs. The HLR based authorization is limited to GPRS and UMTS networks only. There are no standard fields or mechanisms available that allow reuse of a subscriber profile at the HLR for WLAN authorization. The current industry practice is to use an external database for performing WLAN authorization. For example, the protocols like EAP-SIM provide HLR based authentication but do not provide any authorization. Use of external databases is an expensive option both for capital expenditures (as it requires a large and reliable database) and operational reasons (such as synchronization issues). Lack of authorization severely limits the service deployment options for an interworked WLAN system.

Current authorization of users to GPRS services is performed using an external database that reproduces the size of the database in the HLR. In other words, if the HLR has a subscriber database of twenty million users, another database for WLAN authorization must also be created for those twenty million users.

There is an interworking architecture and set of specifications being formulated by the 3GPP WLAN interworking group. These interworking specifications augment the central subscriber database at the HLR (or HSS—Home Subscriber Service) with new fields for WLAN authorization. However, this work is targeted for Release 6 of the 3GPP specifications. That means large scale deployment of networks based on Release 5 and earlier do not benefit from these interworking specifications.

There is therefore a need in the art for an improved method of authorization to WLAN networks in this context.

### Service Authorization in a Wi-Fi Network Interworked with 3G/GSM Network

The present innovations include, in one class of embodiments, a mechanism for authorization of users attempting to access services over a network (such as GPRS/UMTS (3GPP) network) using another network (such as WLAN or WiMax) as an access network. In one example embodiment, using the context of a WLAN access network and a GPRS network, an APN mapping mechanism of the GPRS network is used to provide authorization for WLAN access to subscribers of the GPRS network. For example, in one class of embodiments, a GPRS subscriber's profile in an HLR of the GPRS network is provided with a global WLAN APN to indicate that the subscriber is authorized for WLAN access. The global WLAN APN is also stored on an authorization server, be it an SGSN or another node able to communicate with the GPRS network. When a subscriber of the GPRS network attempts to access the GPRS network using the WLAN as an access network, the authorization server can discriminate against those subscribers according to whether the global WLAN APN is stored in their subscriber profile at the HLR. Users whose subscriber profiles at the HLR include the global WLAN APN are authorized to access the WLAN; users whose subscriber profiles do not include the global WLAN APN are not authorized to access the WLAN.

Thus, in at least one example embodiment, the existing HLR and subscriber profiles are used, without significant modification, so as to provide WLAN access authorization. In preferred embodiments, a single global WLAN APN is used for all users who are authorized to access the WLAN. This allows authorization to be performed without reproducing the HLR subscriber profile database (or one of similar size) at a separate WLAN authorization server.

In another class of embodiments, for every service APN potentially stored in a subscriber profile of the HLR, a corresponding wireless APN is created. In this embodiment, a user has the usual APN in their profile for each service to which they are subscribed, and an additional “service WLAN APN” indicating they are also allowed to access that service via a WLAN access network. The various service WLAN APNs are stored on the authorization server for comparison with the user profiles during authorization. This allows per-service authorization over the WLAN rather than global authorization over the WLAN. Thus, a give user can be authorized to access the service via the usual access network (such as a GPRS access network) and via a WLAN access network. Though this embodiment is more cumbersome, in that it requires a plurality of different service WLAN APNs (e.g., one for each service) rather than the single global WLAN APN of other embodiments, it does permit distinction between the different access networks used by a mobile terminal. This distinction can be advantageous, for example, if billing requirements differ between the access networks used.

In some embodiments, the control channel and traffic channel are divided, and pass through different nodes.

The disclosed innovations, in various embodiments, provide one or more of at least the following advantages:

re-use of the existing HLR capability;

authorization without the need to recreate the HLR database or one similar;

possible distribution of functionality across multiple nodes;

no effect on current HLR functionality;

billing distinction between access network type based on APN used;

applicable to existing HLRs.

### BRIEF DESCRIPTION OF THE DRAWINGS

The disclosed inventions will be described with reference to the accompanying drawings, which show important sample embodiments of the invention and which are incorporated in the specification hereof by reference, wherein:

FIG. 1 shows a prior art network.

FIG. 2 shows a prior art network including means for authenticating WLAN access.

FIG. 3 shows a network consistent with preferred embodiments of the present innovations.

FIG. 4 shows a flowchart of steps consistent with implementing a preferred embodiment of the present innovations.

FIG. 5 shows a network consistent with preferred embodiments of the present innovations.

### DETAILED DESCRIPTION OF THE PREFERRED EMBODIMENTS

The numerous innovative teachings of the present application will be described with particular reference to the presently preferred embodiment (by way of example, and not of limitation).

In a preferred embodiment and context, the present innovations use the service authorization capability of existing GSM networks to provide authorization for a WLAN to subscribers of the GSM network who attempt to reach the GSM network using the WLAN as an access network. For subscribers of a GSM network to use a WLAN as an access network, some form of WLAN authorization must be implemented. However, because many WLANs are not directly part of GSM networks, GSM nodes are not currently equipped to provide WLAN authorization. Though the present innovations are described in the context of a GSM network (and more specifically, a GPRS network) and a WLAN, these innovative concepts are applicable across a wide range of technologies and standards.

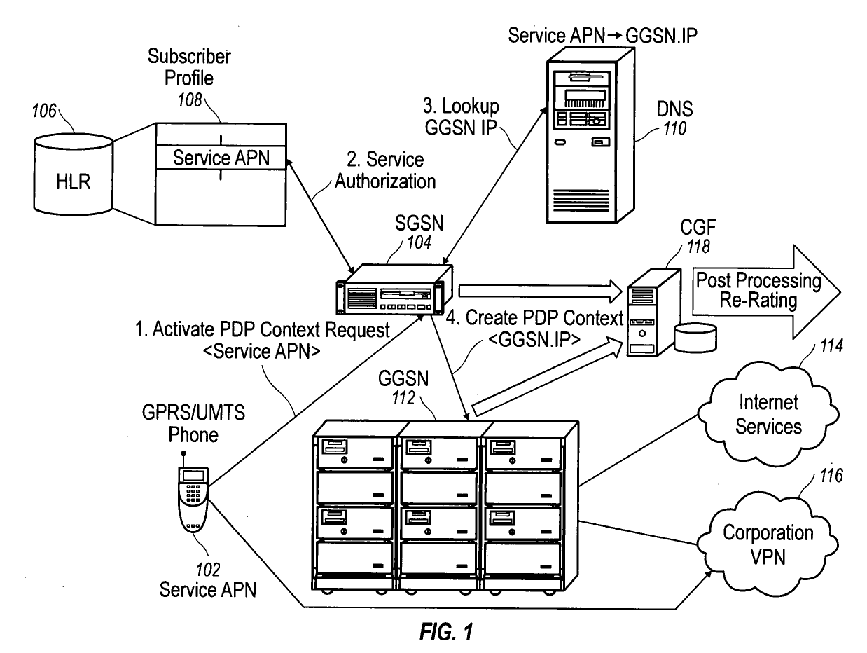

FIG. 1 shows a diagram of a network in which a method of authorization is practiced. The following description depicts a prior art method of using such a network for authorization. This example uses a GPRS/UMTS network interworked with a WLAN. Based on the service or services purchased by the user, the GPRS/UMTS operator populates a subscriber profile 108 associated with that user in the HLR 106, which has a database of profiles for several subscribers. These profiles include service APNs that correspond to the services purchased by the particular subscriber. The APNs can be, for example, fully qualified domain name (FQDN) or a simple text string. The APN is defined in the 3GPP Technical Specification 23.003, which is hereby incorporated by reference.

User equipment 102, such as a cellular telephone or PC card, for example, communicates with SGSN 104 to access the network, including the APN in its Activate PDP Context request. The SGSN 104 pulls the subscriber profile from the HLR 106 and executes the authorization function. This is known as the APN selection algorithm in the 3GPP spec. The outcome of this function is that, based on the subscriber profile, the user is allowed access to the requested service. As described above, the HLR stores information relating to each individual subscriber, including APNs that represent services or networks (for example) that the user is authorized to access.

If the user profile indicates the user should be authorized, the SGSN 104 queries the DNS server 110 to find out which GGSN 112 is responsible for providing the service identified by the service APN. DNS server 110 responds with the IP address of the corresponding GGSN 112. This is typically called an APN resolution procedure. The GGSN 112 is configured with service APNs for which it is responsible. The SGSN 104 then creates a PDP context for the user and facilitates a traffic path from the user equipment 102 to the GGSN 112. Charging Gateway Function (CGF) 118 collects information associated with billing, such as Charging Data Records (CDRs) from various nodes, then mediates and interworks with an operator's proprietary billing system. CDRs can also contain usage session information such as duration, data volume, user identity, server identity, etc.

If the result of the APN resolution procedure is negative (e.g., the service APN does not reside on the GGSN 112), the user is denied authorization. The APN is a mechanism that allows per service and per user authorization. GPRS/UMTS specifications allow subscription to multiple APNs, which can identify a service (e.g., high quality high speed video service) or a network (e.g., a corporate network or the Internet) that is reachable through the GPRS/UMTS network.

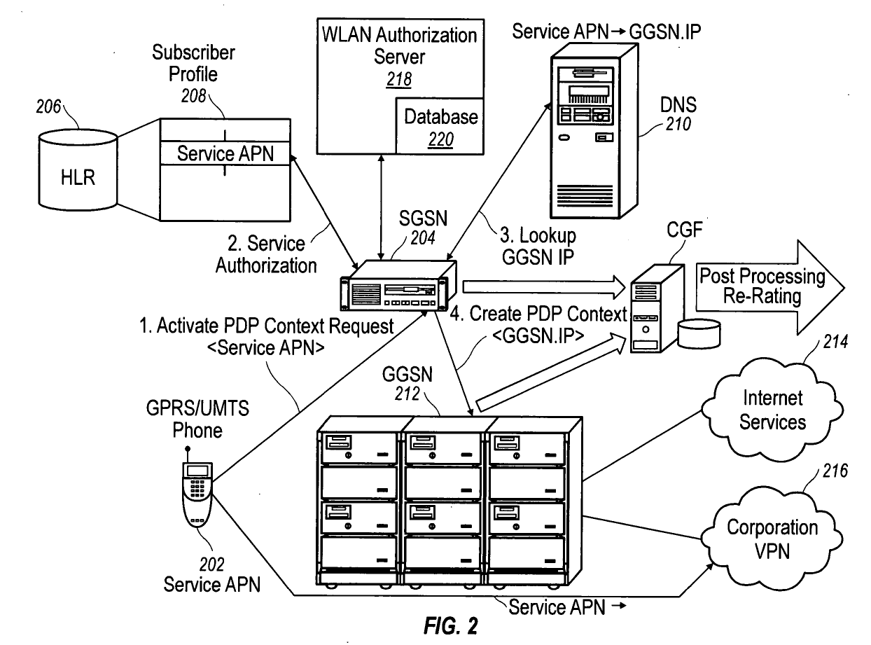

FIG. 2 shows an example of a prior art network used in authorizing subscribers to an interworked WLAN 222. In this example, the database 208 of subscriber information and APNs stored in the HLR 206 is not able to provide authorization information relating to whether the user is authorized to access the WLAN. In order to provide WLAN authorization to subscribers 202, a per-subscriber database 220 for WLAN authorization is used. This database 220, in this example, is stored in a WLAN authorization server 218. The database 220 includes subscriber profiles and APNs that authorize access to the WLAN. In prior art methods of authorization using such a network, if there is an HLR database of 20 million subscribers, the WLAN authorization server must create another database of 20 million record size. The records in the HLR are not reused to provide WLAN authorization. Instead, when WLAN authorization is needed, the SGSN 204 queries the WLAN authorization server 218, which searches its database 220 for the individual subscriber's APN (or similar information) that indicates whether that subscriber is WLAN authorized or not.

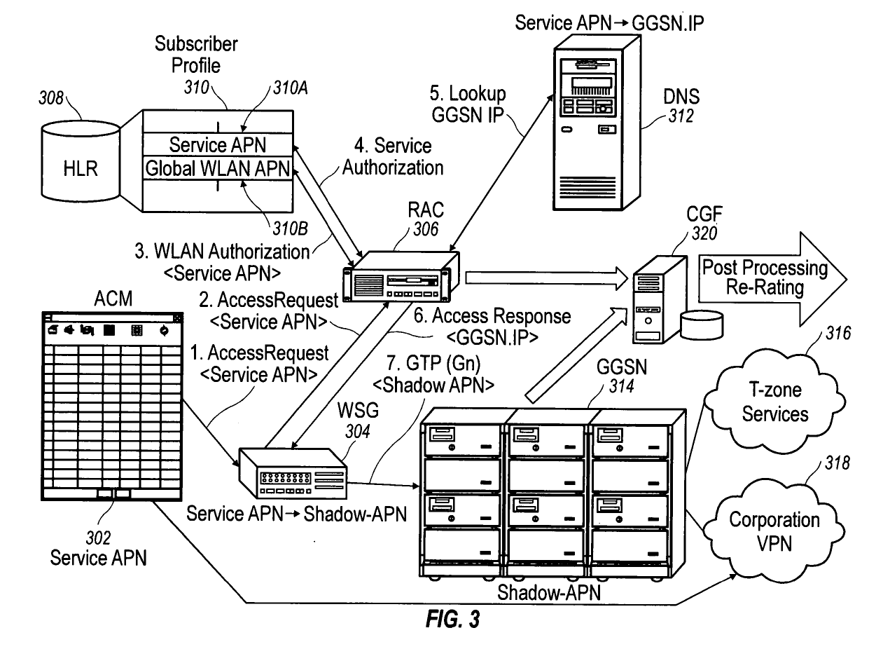

FIG. 3 shows a network consistent with implementing a preferred embodiment of the present innovations. User equipment 302 (or any mobile terminal) communicates with WSG 304 to access Radio Access Controller (RAC) 306. In preferred embodiments, the RAC is a 3GPP AAA server with additional capabilities as described herein. The user identifier included in the access request is typically an IMSI (International Mobile Subscriber Identity) or a temp_id corresponding to the IMSI. In preferred embodiments, RAC 306 is a new node not extant in a typical GPRS network, though the functions of RAC can be implemented using such existing nodes, such as an SGSN. RAC checks HLR 308 for user profile 310, which preferably contains both service APNs 310A and global WLAN APN 310B. Global WLAN APN 310B is only present if the user equipment 302 is authorized to access the network via the WLAN associated with WSG 304 as an access network. RAC determines whether global WLAN APN 310B is present (for example, by a selection algorithm or by a simple comparison or by other means). If it is present, then the user is authorized to access services via the WLAN access network. The RAC 306 queries the DNS server 312 for the address of the GGSN 314, as described above. Access is granted for services, for example, associated with proprietary services 316 or a corporate network 318. CGF 320 collects information, for example, associated with billing.

In preferred embodiments, the global WLAN APN is added to the HLR subscriber profiles according to existing 3GPP specifications for adding APNs for a subscriber. During authorization, after receiving an access request from a user (such as a mobile phone, wireless device, or computer), an authorization server (or an existing node such as the RAC or an SGSN that is provisioned with the global WLAN APN) downloads the subscriber's profile from the HLR and compares the entries to determine if the global WLAN APN is present. If it is, the user is authorized and access is granted. If the global WLAN APN is not present, the user is not authorized.

In preferred embodiments, the authorization request comes over the WLAN itself. Authentication is performed, for example, using the RADIUS protocol. Authentication can be performed using existing nodes or by adding a separate authentication node. Upon successful authentication, the node responsible for authorization requests the subscriber profile associated with that user from the HLR and checks the subscriber profile for the global WLAN APN. Alternately, the authorization node could perform the APN selection algorithm as described in the 3GPP specification for WLAN authorization. In either case, if the subscriber profile includes the global WLAN APN, the user is authorized and the APN resolution function is performed to resolve the authorized APN into a GGSN IP address.

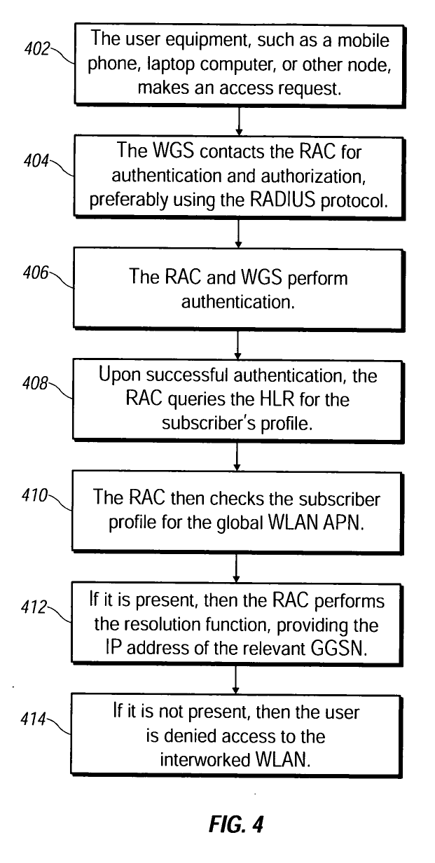

FIG. 4 shows a set of process steps consistent with implementing a preferred embodiment of the present innovations. In this example, the RAC and WGS are used. In this process, the user equipment, such as a mobile phone, laptop computer, or other node, makes an access request (step 402). This access attempt preferably includes an identifier, such as an IMSI. The WGS contacts the RAC for authentication and authorization, preferably using the RADIUS protocol (step 404). The RAC and WGS perform authentication (step 406). Upon successful authentication, the RAC queries the HLR for the subscriber's profile (step 408). The RAC then checks the subscriber profile for the global WLAN APN (step 410). If it is present, then the RAC performs the resolution function, providing the IP address of the relevant GGSN (step 412). If it is not present, then the user is denied access to the interworked WLAN (step 414).

In another class of embodiments, for every service APN potentially stored in a subscriber profile of the HLR, a corresponding wireless APN is created. In this embodiment, a user has the usual APN in that user's profile for each service to which they are subscribed, and an additional “service WLAN APN” indicating they are also allowed to access the same service via a WLAN access network. The various service WLAN APNs are also stored on the authorization server for comparison with the user profiles during authorization. This allows per-service authorization over the WLAN rather than global authorization over the WLAN. Thus, a give user can be authorized to access the service via the usual access network (such as a GPRS access network) and via a WLAN access network. Though this embodiment is more cumbersome, in that it requires a plurality of different service WLAN APNs (e.g., one for each service) rather than the single global WLAN APN of other embodiments, it does permit distinction between the different access networks used by a mobile terminal. This distinction can be advantageous, for example, if billing requirements differ between the access networks used. It is noted this embodiment still enjoys the advantage of not having to reproduce the user database anywhere, as only the set of service WLAN APNs need be stored outside the HLR (for example, in the RAC).

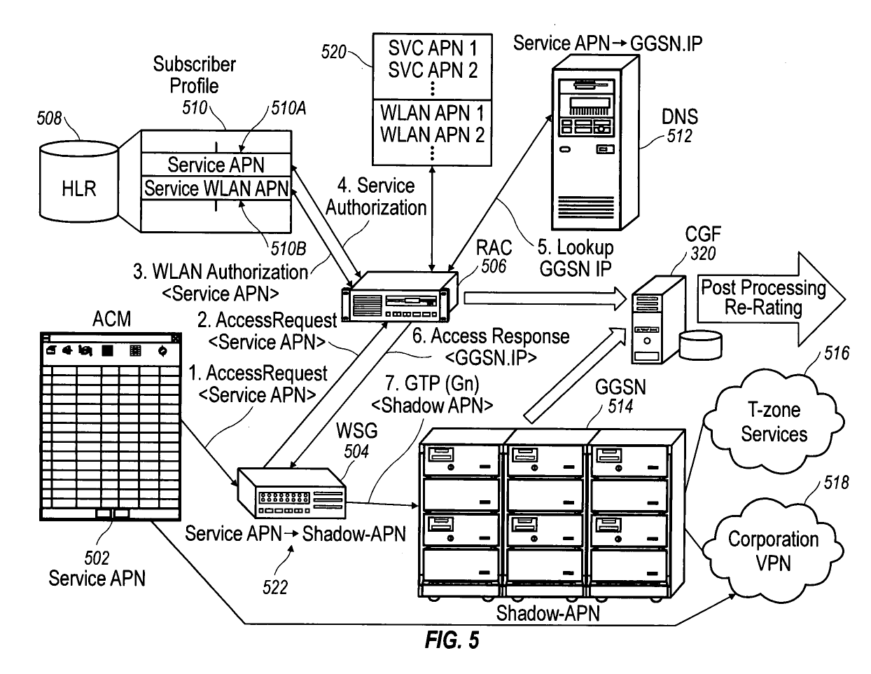

FIG. 5 shows an example embodiment using service WLAN APNs instead of a global WLAN APN. User equipment 502 (or any mobile terminal) communicates with WSG 504 to access RAC 506. In preferred embodiments, RAC 506 is a new node not extant in a typical GPRS network, though the functions of RAC can be implemented using such existing nodes, such as an SGSN. RAC checks HLR 508 for user profile 510, which preferably contains service APNs 510A. When a user tries to get authorization to access the network via WLAN (for example, using WSG 504), the RAC queries a database 520, for example, residing locally or on a different server, to determine (for example, by comparison or algorithm) if the user's profile includes a service WLAN APN to access the service using a WLAN as an access network. If the service WLAN APN is present in user's profile at the HLR, then the user is authorized to access services via the WLAN access network. The RAC 506 queries the DNS server 512 for the address of the GGSN 514, as described above. Access is granted for services, for example, associated with proprietary services 516 or a corporate network 518. CGF 520 collects information, for example, associated with billing.

Another aspect of the present innovations includes a mapping of an input APN (resulting from a selection algorithm, for example) into an outgoing APN towards the GGSN. For example, consider that a user subscribes to an APN identifying corporate access (for example, to proprietary network 518). In the case of a GPRS system, the SGSN (or another node, such as RAC in some embodiments) selects the APN and uses it to create a GTP tunnel toward the GGSN. However, in the case of a WLAN access, the WSG 504 (for example) translates the requested APN (for example, using a mapping function) into a different APN, referred to herein as a shadow APN 522. The shadow APN is recognized by the GGSN and is used to differentiate between WLAN access versus GPRS access, even though from the user's perspective, the same APN is requested. Essentially, depending on the access network used, the authorizing node (or another node that can control which APN is sent to the GGSN) maps the requested APN into a different APN according to which access network was used. The different APNs (including one or more shadow APNs) are used by the GGSN and CGF to, for example, distinguish what kind of access network was used for billing purposes (or other purposes).

According to a disclosed class of innovative embodiments, there is provided: A method of authorizing a user to access a WLAN in accordance with GPRS authorization mechanisms, comprising the steps of: receiving an access request to a service over the WLAN from a user; retrieving a profile associated with the user from a HLR of the home network of the user; determining if a user is authorized to access the WLAN by checking the profile; if the user is allowed to access WLAN, authorizing the user to access the WLAN; and, authorizing the requested service as indicated by the user, by performing a selection algorithm in accordance with the 3GPP specifications.

According to a disclosed class of innovative embodiments, there is provided: A method of identifying the access networks the user is using to access the service, comprising the steps of: receiving a service access request from a user, where a requested service is identified by the service name, in accordance with GPRS specification; retrieving a profile associated with the user from a HLR of the home network of the user; if the user is using WLAN, determining if the user is authorized for WLAN access and requested service; if the user is authorized for WLAN access, determining if a user is authorized to access the requested service by comparing the requested service name and the service name list contained in the profile retrieved from the HLR; if the user is allowed to access the requested service, mapping the service name to another service name according to the pre-defined rule; providing the mapped service name to the gateway node.

According to a disclosed class of innovative embodiments, there is provided: A method of authorizing access to a network, comprising the steps of: identifying a subscriber; retrieving a profile associated with the subscriber, wherein the profile is associated with another network; determining whether the profile includes an indicator that the subscriber is authorized to access a first network by comparing data in the subscriber profile against a stored value.

According to a disclosed class of innovative embodiments, there is provided: A method of authorizing access to a network, comprising the steps of: storing a global WLAN APN in a server that interfaces with database containing authorization data for another network.; comparing the global WLAN APN with entries in a subscriber profile in a database associated with a second network; if the global WLAN APN is in the subscriber profile in the database, then authorizing the subscriber to access the WLAN network.

According to a disclosed class of innovative embodiments, there is provided: A method of authorizing access to a network, comprising the steps of: providing a server with an associated authorization identifier; storing the authorization identifier in one or more subscriber profiles in a register of a second network, wherein the presence of the authorization identifier indicates authorization to access the first network; when a first subscriber of the second network attempts to access the first network, accessing a profile associated with the first subscriber among the one or more subscriber profiles of the second network; and determining whether the authorization identifier is in the profile; and if the authorization identifier is in the first profile, permitting access to the first network.

According to a disclosed class of innovative embodiments, there is provided: A method of authorizing access to a network, comprising the steps of: providing a server with an associated authorization identifier; storing the authorization identifier in one or more subscriber profiles in a register of a second network, wherein the presence of the authorization identifier indicates authorization to access the first network; when a first subscriber of the second network attempts to access the first network, accessing a profile associated with the first subscriber among the one or more subscriber profiles of the second network; and determining whether the authorization identifier is in the profile; and if the authorization identifier is in the first profile, permitting access to the first network.

According to a disclosed class of innovative embodiments, there is provided: A method of authorizing access to a WLAN network, comprising the steps of: adding an authorization indicator to a plurality of user profiles in a HLR; when a user requests access to the network, determining whether the authorization indicator is in a profile of a first user; if the identifier is in the profile of the first user, authorizing the user to access a WLAN network. wherein the authorization indicator is the same for all users authorized to access the network.

According to a disclosed class of innovative embodiments, there is provided: A communication system for authorizing access to a network, comprising: an authorization server; a database of subscriber profiles associated with another network; wherein an authorization server has stored value not associated with any individual subscriber or subscriber profile; wherein when a subscriber attempts to access the network, the server retrieves information from the subscriber's profile and determines whether it permits the access to the network to the subscriber by checking the contents of the subscriber profile against the stored value.

According to a disclosed class of innovative embodiments, there is provided: A communication system comprising: an authorization server; a home location register having user profiles; wherein: a user equipment identifies itself to the authorization server; the authorization server retrieves the user's profile from the HLR; the authorization server compares the user's profile from the HLR against stored value which is not associated with the user and which tells whether the user is authorized to access a WLAN; and if the user's profile has the stored value, the user is authorized to the WLAN.

Modifications and Variations

As will be recognized by those skilled in the art, the innovative concepts described in the present application can be modified and varied over a tremendous range of applications, and accordingly the scope of patented subject matter is not limited by any of the specific exemplary teachings given.

As mentioned above, the present innovations can be implemented in a wide variety of ways without deviating from the innovative concepts disclosed herein. For example, though the current innovations are described in the context of a GPRS network and an interworked WLAN, these concepts could also be applied to other types of networks, of varying areas including both wide area and local.

The specific nodes, process steps, protocols, etc. used in the example implementations described herein are only intended to teach example embodiments of the inventions, and are not intended to suggest that any specific element of an example is necessary to the invention. For example, the authorization functions can be implemented in a single node, or across a variety of nodes. Future implementations and updates to the technology context (e.g., later releases of the 3GPP spec) can benefit from these innovations as well, and the changing context can mean changes in the implementation of these innovative ideas, without deviating from those ideas themselves. Such changes in implementation are considered within the scope of these innovations.

Additional general background, which helps to show variations and implementations, may be found in the following publications, all of which are hereby incorporated by reference: “3G Mobile Networks,” Kasera, Narang, McGraw-Hill (2005).

None of the description in the present application should be read as implying that any particular element, step, or function is an essential element which must be included in the claim scope: THE SCOPE OF PATENTED SUBJECT MATTER IS DEFINED ONLY BY THE ALLOWED CLAIMS. Moreover, none of these claims are intended to invoke paragraph six of 35 USC section 112 unless the exact words “means for” are followed by a participle.

1. A method of authorizing a user to access a WLAN in accordance with GPRS authorization mechanisms, comprising the steps of:
receiving an access request to a service over the WLAN from a user;
retrieving a profile associated with the user from a HLR of the home network of the user;
determining if a user is authorized to access the WLAN by checking the profile;
if the user is allowed to access WLAN, authorizing the user to access the WLAN; and,
authorizing the requested service as indicated by the user, by performing a selection algorithm in accordance with the 3GPP specifications.

2. The method of claim 1, wherein the step of determining is done by comparing one or more entries in the profile against a stored value at an authorization node.

3. The method of claim 1, wherein a single common global WLAN APN in the profile associated with the user is used to authorize the WLAN access for a plurality of users by its presence, where, in HLR, only the profile of the user who is authorized to access WLAN contains this common global WLAN APN.

4. The method of claim 1, wherein the single common global WLAN APN is stored on a server that provides authorization services.

5. The method of claim 1, wherein a service WLAN APN in the profile associated with the user is used to authorize the WLAN access and the requested service indicated by the user.

6. The method of claim 1, wherein the service WLAN APN corresponds to the service APN with additional identifier that indicates the authorization to access the service through WLAN.

7. The method of claim 1, wherein the list of service WLAN APNs or pre-defined rule to identify the WLAN access are stored on a server that provides authorization services.

8. (canceled)

9. The method of claim 1, wherein the profiles of the users, in HLR, who are authorized to access WLAN contains both lists of GPRS APNs and service WLAN APNs, where the GPRS APN is used to authorize the user to the service in GPRS network and the service WLAN APN is used to authorize the user to the service in WLAN network.

10. The method of claim 1, wherein a combined service WLAN APN in the profile associated with the user is used to authorize the WLAN access and the requested service indicated by the user.

11. The method of claim 1, wherein the combined service WLAN APN corresponds to the service APN with additional identifier that indicates the authorization to access the service through WLAN.

12. The method of claim 1, wherein the list of combined service WLAN APNs or pre-defined rule to identify the WLAN access are stored on a server that provides authorization services.

13. (canceled)

14. The method of claim 1, wherein the profiles of the users, in HLR, who are authorized to access WLAN contains only the list of combined service WLAN APNs, where the combined service WLAN APN is used to authorize the user to the service both in GPRS network and the WLAN network.

15. A method of identifying the access networks the user is using to access the service, comprising the steps of:
receiving a service access request from a user, where a requested service is identified by the service name, in accordance with GPRS specification;
retrieving a profile associated with the user from a HLR of the home network of the user;
if the user is using WLAN, determining if the user is authorized for WLAN access and requested service;
if the user is authorized for WLAN access, determining if a user is authorized to access the requested service by comparing the requested service name and the service name list contained in the profile retrieved from the HLR;
if the user is allowed to access the requested service, mapping the service name to another service name according to the pre-defined rule;
providing the mapped service name to the gateway node.

16. The method of claim 15, wherein the service name is a GPRS APN, in accordance to the GPRS specification.

17. The method of claim 15, wherein the mapped service name is used to identify the access network the user is using to access the service.

18. The method of claim 15, wherein the pre-defined rule is applied to the GPRS APN to distinguish the service access through GPRS network and the WLAN network.

19. The method of claim 15, wherein the pre-defined rule is the mapping table or mapping rule between the GPRS APN and the shadow APN.

20. The method of claim 15, wherein the gateway node is a GGSN

21. The method of claim 15, wherein the GGSN uses the shadow APN to identify the access network the user is using, to distinguish the charge according to the access network, and to handle and/or route the traffic according to the policy.

22. (canceled)

23. A method of authorizing access to a network, comprising the steps of:
identifying a subscriber;
retrieving a profile associated with the subscriber, wherein the profile is associated with another network;
determining whether the profile includes an indicator that the subscriber is authorized to access a first network by comparing data in the subscriber profile against a stored value.

24 to 52. (canceled)
